(19) United States
(12) Patent Application Publication
(10) Pub. No.: US 2015/0083352 A1
(43) Pub. Date: Mar. 26, 2015

(54) CURTAIN PANEL WITH FLIP TABS BEARING GROMMETS

(71) Applicant: PEKING HANDICRAFT, INC., South San Francisco, CA (US)

(72) Inventor: Maria Buxkemper-Odenkirk, McFarland, WI (US)

(73) Assignee: PEKING HANDICRAFT, INC., South San Francisco, CA (US)

(21) Appl. No.: 14/168,783

(22) Filed: Jan. 30, 2014

Related U.S. Application Data
(60) Provisional application No. 61/881,248, filed on Sep. 23, 2013.

(51) Int. Cl. A47H 15/02; B32B 37/12

(52) U.S. Cl. CPC A47H 15/02; B32B 37/12
USPC 160/348; 156/60; 29/428

(57) ABSTRACT

A curtain panel with a front-facing side and a back side includes a panel with a predetermined dimension, a plurality of spaced flip tabs attached to a top section of the back side of the panel, and a plurality of grommets, each of said grommets being embedded in said flip tab through an opening formed in said flip tab. The grommets are aligned to receive a curtain rod and are further configured to glide on said rod for easy hanging, opening, and closing the panel.

### CROSS-REFERENCE TO RELATED APPLICATIONS

The present application claims the benefit of the Provisional Patent Application No. 61/881,248 filed on Sep. 23, 2013, the entire disclosure of which is incorporated herein by reference.

### FIELD OF USE

The present disclosure relates to a curtain panel with flip tabs, and more particularly, to a curtain panel with a plurality of spaced flip tabs with grommets embedded therein to facilitate hanging, opening, and closing the curtain panel.

### BACKGROUND

Typically, plain or pinch pleat panels used as window or shower curtains require extra hardware like drapery hooks, rings, or pins for installing, opening, and closing the curtains. However, drapery hooks, rings, or pins used to hang a plain or pinch pleat panel for a window are cumbersome, inconvenient, and often not applicable to the convenience of from-store-to-window offerings.

Many other home goods such as shower curtains and draperies have leveraged this type of attachment using grommets to assist consumers with the convenience of the ease of attachment. In some readymade window treatment categories, grommets are directly attached to a panel itself and are aligned to receive a curtain rod.

However, if the grommets are directly attached to the panel itself, a curtain rod must be inserted into the panel itself and can be exposed from both front and back sides of the panel, which is not desirable from the aesthetic perspective. Also, the lifetime and durability of the panel can be adversely affected by directly attaching the grommets to the panel itself.

What is desirable is a new window or shower curtain panel that can be conveniently mounted, opened, and closed on a curtain rod via flip tabs bearing grommets, that does not require all extra hardware like drapery hooks, rings, or pins for customer to install the curtain panel, that does not impact the manufacturing cost, and that does not expose the curtain rod when it was installed, opened, and closed.

### SUMMARY

The present disclosure relates to a curtain panel with flip tabs bearing grommets configured to glide on a curtain rod for easy hanging, opening, and closing the panel. The present disclosure eliminates the need for extra hardware including drapery pins or hooks. Additionally, the disclosed curtain panel allows for easy and smooth hanging, opening, and closing the panel without any additional mechanism, and no part of the curtain rod can be seen when installed.

According to one aspect of the present disclosure, a curtain panel with flip tabs for easy hanging, opening, and closing the panel is disclosed. A curtain panel with a front-facing side and a back side includes a panel with a predetermined dimension, and a plurality of spaced flip tabs attached to a top section of the back side of the panel and a plurality of grommets embedded in said flip tab. Each of the plurality of grommets is affixed to the flip tab such that the grommets are aligned to receive a curtain rod and are configured to glide on said rod for easy hanging, opening, and closing the panel.

According to another aspect of the present disclosure, a method for manufacturing a curtain panel with flip tabs is disclosed. The method includes providing a panel with a predetermined dimension, and providing a flip tab with a grommet affixed to the flip tab through an opening formed in said flip tab. The method further includes attaching said flip tab to a top section of the back side of the panel such that the panel has pre-spaced and aligned grommets thereon.

The details of one or more embodiments of the present invention are set forth in the accompanying drawings and the description below. Other features, objects, and advantages of the present invention will be apparent from the description and drawings, and from the claims.

### BRIEF DESCRIPTION OF THE DRAWINGS

The accompanying drawings, which are incorporated in and constitute a part of this specification, illustrate exemplary embodiments of the invention and together with the description, serve to explain the principles of the invention. In the drawings:

FIG. 1A illustrates a back side of a curtain panel with a plurality of flip tabs attached to a top section of the panel according to an embodiment of the present disclosure;

FIG. 1B illustrates a front-facing side of a curtain panel with a plurality of spaced pleats according to an embodiment of the present disclosure;

FIG. 2A illustrates a partial side view of a curtain panel with flip tabs bearing grommets therein according to an embodiment of the present disclosure;

FIG. 2B illustrates a partial side view of a curtain panel with flip tabs embedded with grommets therein that are aligned to receive a rod according to an embodiment of the present disclosure;

FIG. 2C is a photographic partial side view of a curtain panel with flip tabs bearing grommets therein that are aligned to receive a rod according to an embodiment of the present disclosure; and

FIG. 3 is a flow chart depicting a process of manufacturing a curtain panel with flip tabs according to an embodiment of the present disclosure.

The drawings depict various preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The present disclosure relates to a curtain panel with flip tabs for easy hanging, opening, and closing the panel. An embodiment will be described below with reference to the accompanying drawings.

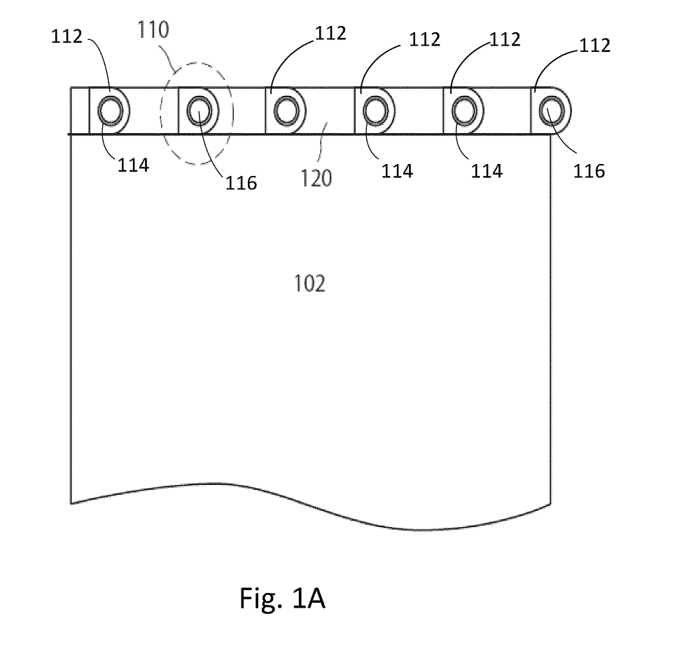

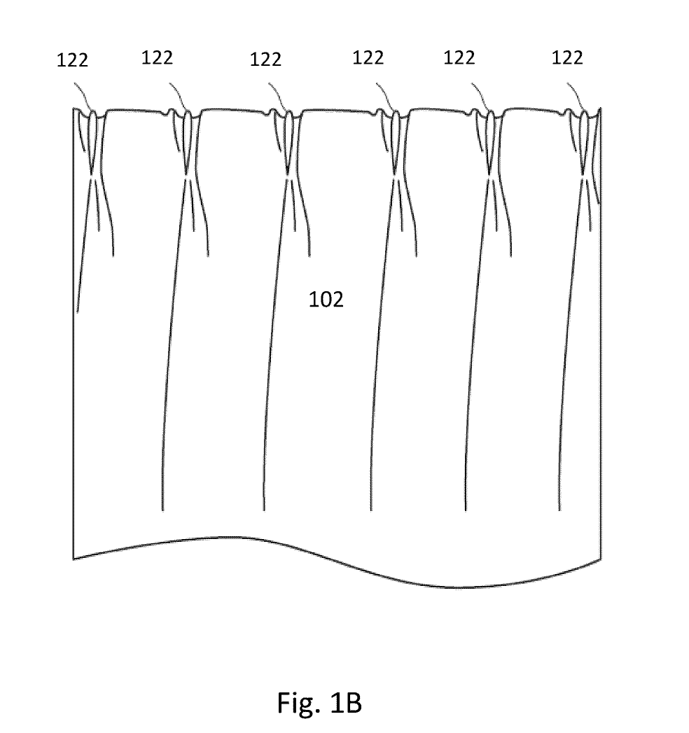

FIG. 1A illustrates a back side of a curtain panel where a plurality of flip tabs are attached to a top section of the panel according to an embodiment of the present disclosure. The panel 102 can be applied to a drapery or a curtain design such that the installation process of the drapery or curtain in a home would be much easier.

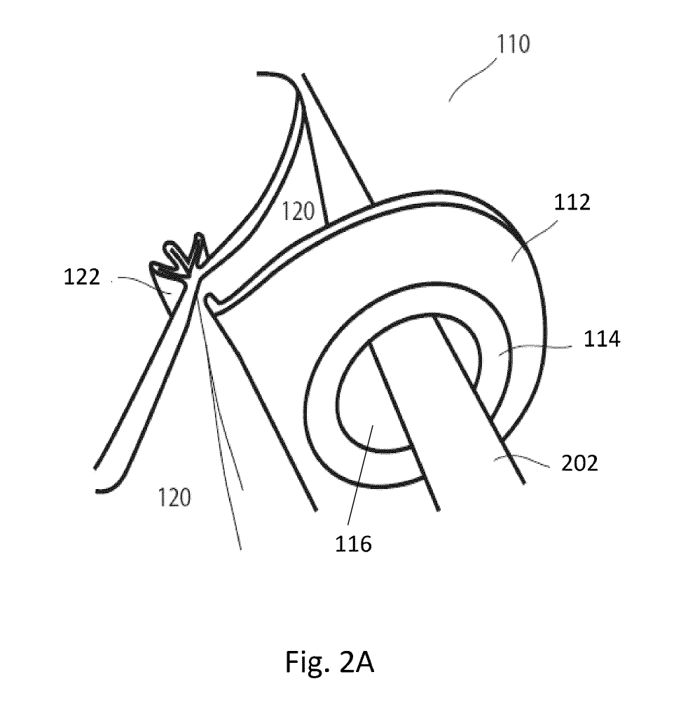

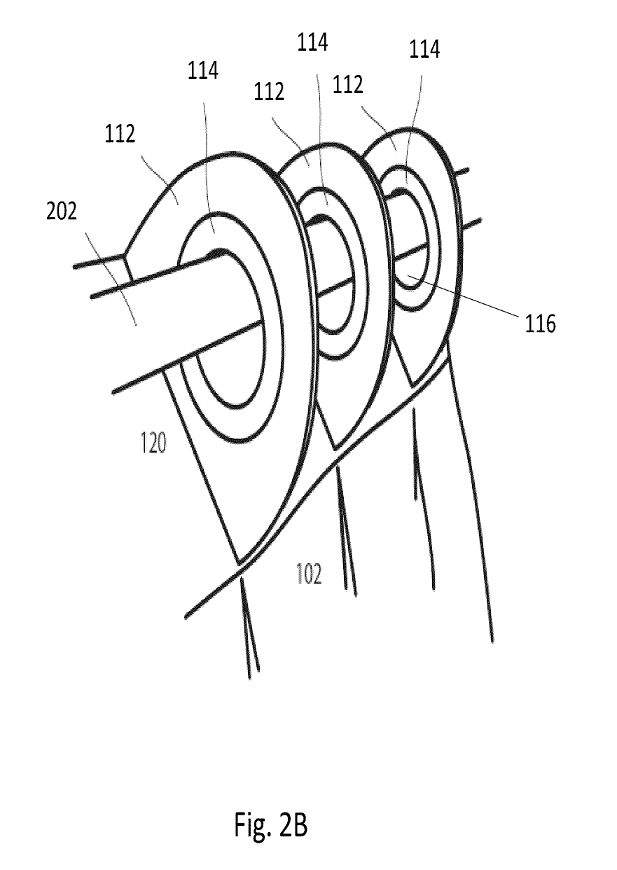

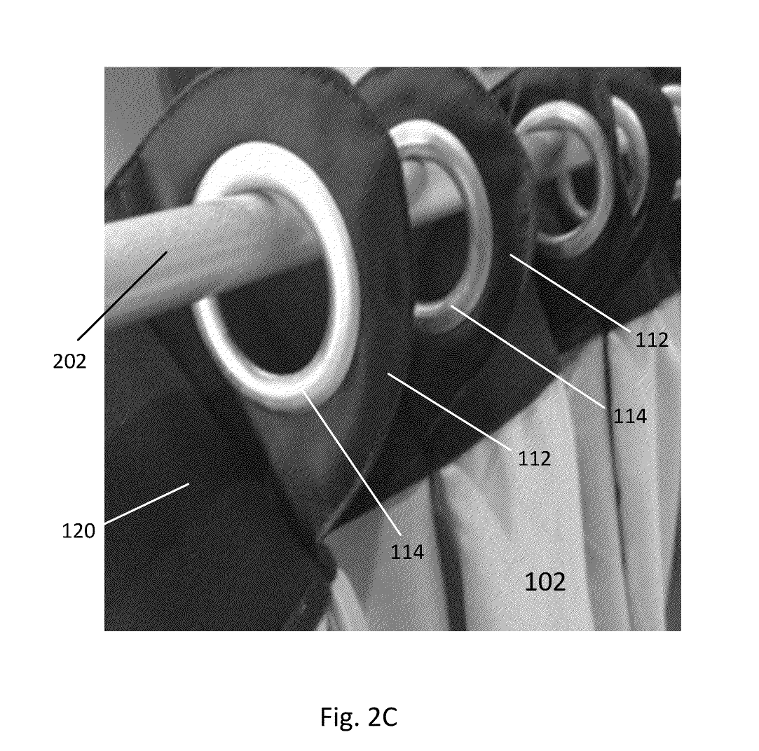

Referring to FIG. 1A, the panel 102 has a top section 120 disposed across the panel 102 on which a plurality of spaced flip tabs 112 are attached. The top section 120 is a portion of the panel 102 to which the plurality of flip tabs are affixed and aligned to receive a horizontal curtain rod 202 (FIG. 2A) to support the entire panel 102. The flip tab 112 is semi-circle in shape as further shown in FIGS. 2A and 2B, but the shape of the flip tab is not limited to the semi-circled shape. The flip tab 112 is generally evenly spaced across the top section 120 of the panel 102. The flip tab 112 can be formed of any flexible sheet material such as fabric, vinyl, leather, or the like, and can be made of polyester, cotton, linen, silk, or other fabric types including blends such as poly cotton, and the like. In one embodiment, the flip tab 112 is made of polyester or a combination of polyester and cotton, polyester and rayon, polyester and acetate, or all other fabric types. If the flip tab is made of fabric, it can be interlined with interlining materials including polyester, cotton, rayon, or acetate, etc. for stability and durability.

The flip tab 112 is designed to have an opening 116 formed in approximately the center portion to accommodate a grommet 114. The grommet is placed within the opening 116 of the flip tab and is affixed to the flip tab along the edge defined by the opening 116 formed within the flip tab 112. The flip tab with grommet embedded therein 110 is then attached by various known methods to the top section 120 of the panel 102. A plurality of flip tabs with grommets embedded therein are aligned to receive a curtain rod 202 as shown in FIGS. 2A and 2B such that the panel 102 can be easily mounted on the rod 202, opened, and closed smoothly.

FIG. 1B illustrates a front-facing side of the curtain panel 102 where a plurality of spaced pleats 122 are formed according to one exemplary embodiment of the present disclosure. The panel 102 can be formed of any flexible sheet material similar to that of the flip tab 112, such as fabric, vinyl, leather, or the like. In one embodiment, the panel 102 can be a plain fabric with no pinch pleats formed therein. In another embodiment, the panel 102 can have a plurality of spaced pinch pleats 122 along the top section of the panel to give the panel 102 an aesthetically pleasing appearance as shown in FIGS. 1B and 2C. A buckram (not shown) is a form of a liner that can be often used as a stiffener. For the purpose of the pleats 122, a buckram can be used to hold the shape of the pleats 122 in place. Optionally, the flip tab 112 can be interlined with buckram for stability and durability.

FIG. 2A illustrates a partial side view from the back side of a curtain panel with flip tabs embedded with grommets therein according to an embodiment of the present disclosure. As described above, the pleat 122 is formed on the front-facing side of the panel 102, while the flip tab 112 is attached on the top section of the back side of the panel 102 as shown in FIG. 2A. A grommet 114 is affixed to the flip tab 112 through an opening 116 formed in approximately the center portion of the flip tab 112. The flip tab 112 is sewn or attached by other means to the back side of the panel 102 on its top section 120.

FIG. 2B illustrates a partial side view from the back side of a curtain panel with flip tabs embedded with grommets therein that are aligned to receive a curtain rod according to one exemplary embodiment of the present disclosure. Referring to FIG. 2B, the panel 102 is designed to be suspended from and movable along a horizontally extending curtain rod 202. The rod 202 can be attached to a wall or to a window frame above or in front of the window. The flip tabs 112 being embedded with the grommets 114 can be easily aligned to receive the rod 202, and thus no drapery hooks, rings, or pins are utilized to hang the panel from the rod. FIG. 2C is a photographic partial side view from the back side of the curtain panel 102 with a plurality of flip tabs 112 each being embedded with a grommet 114 therein that are aligned to receive a curtain rod 202 according to an embodiment of the present disclosure.

Referring to FIGS. 1A and 2B, the flip tabs 112 that are embedded with the grommets 114 are disposed at spaced intervals along the top section of the panel 102. The flip tabs 112 are aligned to receive a horizontal curtain rod 202 to support the panel 102. As shown in FIGS. 2B and 2C, the grommets 114 are essentially hollow rigid rings, and are used with curtain rod having a circular cross-sectional configuration. Grommets 114 are commonly made of metal, but are not specifically limited to metal. For example, grommets can be formed of plastic or other materials including resin, metal formed over plastic, or bamboo, etc.

Each grommet is placed within an opening 116 formed in each flip tab 112 as illustrated in FIGS. 1A and 2A. In one embodiment, the grommet 114 may have a circumferential channel adapted to engage the flip tab 112 along a boundary formed by the opening 116 to be attached to the flip tab. In another embodiment, the grommet 114 can be sewn to the flip tab. In either way, each grommet disposed within a flip tab eliminates the need to use extra hardware such as drapery hooks, rings, or pins to hang the panel, thereby allowing for easy installing, opening, and closing the panel.

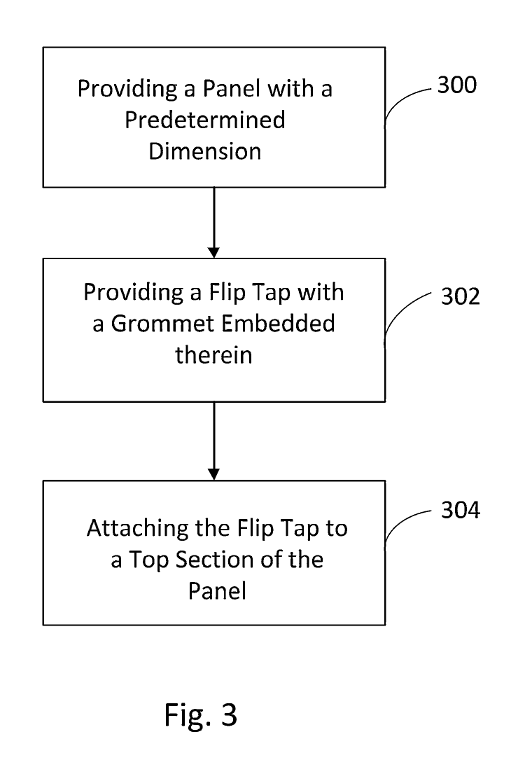

FIG. 3 is a flow chart depicting a process of manufacturing a curtain panel with flip tabs according to an embodiment of the present disclosure. The manufacturing process begins at step 300 where a curtain panel with a predetermined dimension is provided. As one exemplary embodiment, the panel 102 is about 84 inches long and 25 inches wide. However, there are many readymade panels with different width and length, the panel 102 is not limited to a specific dimension in either width or length. The panel with flip tabs as disclosed in the present disclosure can be applied to any types of curtains such as window curtains, shower curtains, or kitchen curtains. At step 302, a flip tab embedded with a grommet is provided. Each flip tab with grommet embedded therein can be attached to the top section of the panel by sewing or by other known means at step 304.

Since the grommets are not directly affixed to the panel itself, the panel does not have to be cut out to form openings to receive grommets. Since the panel itself is not perforated to receive the grommet, the durability of the panel improves. Also, the manufacturing processes can be simplified and the manufacturing cost can be reduced because pre-manufactured flip tabs can be simply affixed to the panel by sewing or by using Velcro, glue, or snapper, or by other known methods. Accordingly, it would be advantageous to provide a window treatment having a curtain panel with a plurality of flip tabs embedded with grommets because the resulting panel can be manufactured with reduced manufacturing steps and costs, and the durability of the panel improves. Also, with the above design, the curtain rod is not exposed from the front-facing side when the panel is installed, thereby providing an improved panel design from the aesthetic perspective.

The curtain panel with flip tabs works well with any standard or regular curtain rod. Since no extra hardware is needed to hang, open, or close the panel, the disclosed curtain panel eliminates the need for drapery hooks, rings, or pins and provides simplified installation, easy and convenient opening and closing of the panel. Since the disclosed curtain panel can be simply hung from the rod, no extra effort to get the hooks inserted into the right spot and no extra cost in purchasing extra hardware is incurred.

It is to be understood that the present disclosure is not limited to the illustrations described and shown herein, which are deemed to be merely illustrative of the best modes of carrying out the invention, and which are susceptible to modification of form, size, arrangement of parts, and details of operation. The present disclosure is intended to encompass all such modifications which are within its spirit and scope of the invention as defined by the following claims.

What is claimed is:

1. A curtain panel with a front-facing side and a back side, comprising:
a panel with a predetermined dimension;
a plurality of spaced flip tabs attached to a top section of the back side of the panel; and
a plurality of grommets, each of said grommets being embedded in said flip tab, wherein said grommets are aligned to receive a curtain rod and are configured to glide on said rod.

2. The curtain panel of claim 1, wherein the panel has a plurality of spaced pleats formed on the front-facing side of the panel.

3. The curtain panel of claim 1, wherein said flip tab is formed of any flexible sheet material such as fabric, vinyl, or leather.

4. The curtain panel of claim 1, wherein said flip tab is formed of polyester, cotton, rayon, linen, silk, or blends of poly cotton.

5. The curtain panel of claim 1, wherein said flip tab is interlined with a buckram to increase stability.

6. The curtain panel of claim 1, wherein said flip tab is sewn into the top section of the panel.

7. The curtain panel of claim 1, wherein said flip tab is affixed to the top section of the panel by using glue or snapper.

8. The curtain panel of claim 1, wherein said flip tab is affixed to the top section of the panel by using Velcro attached to both flip tab and panel.

9. The curtain panel of claim 1, wherein said grommet is formed of a metal, a plastic, a resin, a metal over plastic, or other materials.

10. A method for manufacturing a curtain panel with a front-facing side and a back side, comprising:
providing a panel with a predetermined dimension;
providing a flip tab with a grommet embedded in said flip tab;
attaching said flip tab to a top section of the back side of the panel such that the panel has pre-spaced and aligned grommets thereon.

11. The method of claim 10, wherein the panel has a plurality of spaced pleats formed on the front-facing side of the top section of the panel.

12. The method of claim 10, wherein said flip tab is formed of any flexible sheet material such as fabric, vinyl, leather, or the like.

13. The method of claim 10, wherein said flip tab is formed of polyester, cotton, rayon, linen, silk, or blends of poly cotton.

14. The method of claim 10, wherein said flip tab is interlined with a buckram to increase stability.

15. The method of claim 10, wherein said flip tab is affixed to the panel by being sewn into the top section of the panel.

16. The method of claim 10, wherein said flip tab is affixed to the top section of the panel by using glue or snapper.

17. The method of claim 10, wherein said flip tab is affixed to the top section of the panel by using Velcro attached to both flip tab and panel.

18. The method of claim 10, wherein said grommet is formed of a metal, a plastic, a resin, a metal over plastic, or other materials.
